(19) United States
(12) Patent Application Publication
(10) Pub. No.: US 2022/0318769 A1
(43) Pub. Date: Oct. 6, 2022

(54) ELECTRONIC APPARATUS FOR PROCESSING ITEM SALES INFORMATION AND METHOD THEREOF

(71) Applicant: Coupang Corp., Seoul (KR)

(72) Inventors: Chang Hwan Han, Seoul (KR); An Na Cho, Seoul (KR); Jong Kook Chung, Seoul (KR); Mi Sung Bae, Seoul (KR); Jae Uk Lee, Seoul (KR); Hae Seong Jeon, Seoul (KR); Young Kyo Jung, Seoul (KR); Byung Jae Kim, Seoul (KR)

(21) Appl. No.: 17/318,895

(22) Filed: May 12, 2021

(30) Foreign Application Priority Data
Mar. 31, 2021 (KR) 10-2021-0041890

(51) Int. Cl. G06Q 20/02; G06Q 20/40

(52) U.S. Cl. CPC G06Q 20/02; G06Q 20/405; G06Q 20/4037; G06Q 20/12

(57) ABSTRACT

Disclosed is a method of processing item sales information by an electronic apparatus, the method including obtaining a purchase request, which includes item information related to an item selected by a user and information related to a payment option, providing, when the item information corresponding to the item and the information related to the payment option satisfy a first condition, the user with a purchase response, which includes approval information corresponding to the purchase request, in response to the purchase request, prior to payment of the item by the user through the payment option, generating release request information for the item, and generating settlement information corresponding to the cost of the item, wherein the cost of the item is settled with the seller on the basis of the settlement information.

### BACKGROUND

### Technical Field

The present disclosure relates to an electronic apparatus for processing item sales information and a method thereof. More specifically, the present disclosure relates to an electronic apparatus for providing a purchase response, including approval information corresponding to a purchase request for an item, in response to the purchase request prior to payment of the item, generating release request information for the item, generating settlement information corresponding to the cost of the item, and settling the cost of the item with a seller of the item on the basis of the settlement information; and a method thereof.

### Description of the Related Art

With the development of electronic technology, e-commerce has occupied a main position in the field of shopping. Customers can purchase items online without visiting shopping malls or markets, and items purchased online are delivered to destinations requested by customers.

In the case of e-commerce, customers are likely to enter their own personal information when subscribing to a website and item purchase histories of the customers on the website are easy to grasp, and therefore, the customers' purchasing tendencies or reliability may be easily determined, compared to offline commerce.

In the case of e-commerce, an item may be paid for through a financial institution such as a bank. However, the payment of the item may be limited due to reasons, including an examination of a financial institution during the payment of the items, a customer's insufficient bank account balance, and the like. In this case, the customer cannot purchase a desired item immediately and thus inconvenience may be caused to the customer. In particular, when it is determined based on the customer's payment history that the customer is reliable (that is, it is determined that the customer is willing to and able to pay for the item at a later time), the customer may be allowed to purchase the item prior to the payment of the item, so that the customer may be provided with convenience in terms of commercial transaction and the item may be delivered to the customer without delay.

When the customer is allowed to purchase an item prior to the payment of the item, it is important to determine when and how to settle the cost of the item with the seller of the item. In addition, it may be necessary to consider whether the seller is reliable and is willing to provide the item to the customer prior to the payment of the item.

In this connection, related art documents such as KR20070029367A and KR100583181B1 may be referred to.

### SUMMARY

### Technical Goals

An aspect provides an electronic apparatus for providing a purchase response, which includes approval information corresponding to a purchase request for an item, in response to the purchase request prior to the payment of the item, generating release request information for the item, generating settlement information corresponding to the cost of the item, and settling the cost of the item with a seller of the item on the basis of the settlement information; and a method thereof.

Technical goals to be achieved through the example embodiments are not limited to the technical goals as described above, and other technical tasks can be inferred from the following example embodiments.

### Technical Solutions

According to an aspect, a method of processing item sales information by an electronic apparatus includes: obtaining a purchase request, which includes item information related to an item selected by a user and information related to a payment option; when the item information corresponding to the item and the information related to the payment option satisfy a first condition, providing the user with a purchase response in response to the purchase request, prior to payment of the item by the user through the payment option, the purchase response including approval information corresponding to the purchase request; generating release request information for the item; and generating settlement information corresponding to the cost of the item. The cost is settled with a seller of the item on the basis of the settlement information.

According to an example embodiment, the item information may include price information of the item, the information related to the payment option may include at least one of information as to whether the payment option is available and balance information related to a limit amount of the payment option, and the providing of the purchase response may include determining whether the first condition is satisfied on the basis of at least one of the price information of the item, whether the payment option is available, and the balance information of the payment option, in response to the obtaining of the purchase request.

According to an example embodiment, whether the payment option is available and the limit amount of the payment option may be determined on the basis of at least one of seller information corresponding to the seller and user information corresponding to the user.

According to an example embodiment, the seller information may include reliability set in relation to the seller, and the reliability may be determined based on at least one of a sales history corresponding to the seller, rating information corresponding to the seller, a subscription period corresponding to the seller, a credit score corresponding to the seller, and information obtained from affiliates.

According to an example embodiment, the sales history may include at least one of a list of one or more items sold by the seller, a payment option used to pay for the one or more items, and product reviews written with for the one or more items.

According to an example embodiment, the method may further include providing a benefit related to the sale of the item when the reliability is greater than a predetermined first value.

According to an example embodiment, the seller information may include information about a limit amount, which is permitted by the seller, to purchase the item using the payment option.

According to an example embodiment, whether the payment option is available and the limit amount of the payment option may be determined on the basis of the item information.

According to an example embodiment, whether the payment option is available and the limit amount of the payment option may be determined on the basis of at least one of category information of the item, information about a comparison between the price information of the item and another piece of price information, information about the number of sales of the item, and at least one piece of user information corresponding to one or more users who have purchased the item.

According to an example embodiment, the at least one piece of the user information may include at least one of a purchase history corresponding to the one or more users, rating information corresponding to the one or more users, a subscription period corresponding to the one or more users, and a credit score corresponding to the one or more users.

According to an example embodiment, the method may further include requesting the user to pay at least part of costs corresponding to one or more purchase requests related to the payment option, as a settlement date corresponding to the payment option is approaching.

According to an example embodiment, the requesting the user to pay at least part of the costs may include transmitting a payment request to a first server corresponding to a first payment method designated to correspond to the payment option.

According to an example embodiment, the generating of the settlement information may include determining to settle the cost of the item with the seller when the user pays the cost of the item, in response to the purchase request.

According to an example embodiment, the generating of the settlement information may include determining to settle the cost of the item with the seller when a settlement date corresponding to the payment option is approaching.

According to an example embodiment, the generating of the settlement information may include determining to settle the cost of the item with the seller when a predetermined time elapses after the providing of the purchase response.

According to an example embodiment, the settlement information may include first settlement information corresponding to an amount paid by the user and settled with the seller in response to the purchase request, and second settlement information corresponding to an amount settled with the seller before the amount is paid by the user.

According to an example embodiment, the providing of the purchase response may include: determining whether the item is a target for delivery; providing the purchase response for the item when the item is a target for delivery; and providing information for rejection of the purchase request for the item when the item is not a target for delivery.

According to an aspect, an electronic apparatus for processing item sales information includes: a transceiver, a memory storing instructions, and a processor, and the processor is connected to the transceiver and the memory and configured to: obtain a purchase request, which includes item information related to an item selected by a user and information related to a payment option; when the item information corresponding to the item and the information related to the payment option satisfy a first condition, provide the user with a purchase response in response to the purchase request, prior to payment of the item by the user through the payment option, the purchase response including approval information corresponding to the purchase request; generate release request information for the item; and generate settlement information corresponding to the cost of the item. The cost of the item is settled with a seller of the item on the basis of the settlement information.

Other example embodiments are provided in detail in the detailed description and drawings.

### Effects

According to the present disclosure, in an electronic apparatus for processing item sales information and a method thereof, when an item is for sale in an e-commerce market, a purchase response including approval information corresponding to a purchase request can be provided prior to the payment of an item through a payment option, and release request information for the item can be generated, thereby ensuring a reliable user's immediate purchase of the item and the delivery of the item and providing convenience in the purchase of the item.

According to the present disclosure, an electronic apparatus for processing item sales information and a method thereof are capable of generating settlement information corresponding to the cost of an item and settling the cost of the item with the seller of the item on the basis of the settlement information, and therefore, a method of how to settle the cost of the item with the seller can be provided, in response to the providing of a purchase response before the payment of the item and the generation of release request information.

Effects of the present disclosure are not limited thereto, and other effects that are not mentioned herein will be clearly understood by those of ordinary skill in the art from the following claims.

### BRIEF DESCRIPTION OF THE DRAWINGS

FIG. 1 is a schematic configuration diagram illustrating an item sales information processing system according to an example embodiment.

FIG. 2 is a flowchart of an information processing method in an item sales information processing system according to an example embodiment.

FIG. 3 is a flowchart of an operation of requesting to deliver an item by an electronic apparatus in an item sales information processing system according to an example embodiment.

FIG. 4 is a diagram for describing an example of a user interface (UI) provided by an electronic apparatus to provide a “pay later” service in an item sales information processing system according to an example embodiment.

FIG. 5 is a diagram for describing an example in which use of the “pay later” service is limited in relation to the purchase of an item in an item sales information processing system according to an example embodiment.

FIG. 6 is a flowchart of a method of processing item sales information by an electronic apparatus according to an example embodiment.

FIG. 7 is a diagram illustrating an example of a configuration of an electronic apparatus for processing item sales information according to an example embodiment.

### DETAILED DESCRIPTION

In example embodiments, general terms that have been widely used nowadays are selected, when possible, in consideration of functions of the present disclosure, but non-general terms may be selected according to the intentions of technicians in the this art, precedents, or new technologies, etc. Some terms may be arbitrarily chosen by the present applicant, and in this case, the meanings of these terms will be explained in corresponding parts of the present disclosure in detail. Accordingly, the terms used herein should be defined not based on the names thereof but based on the meanings thereof and the whole context of the present disclosure.

It will be understood that when an element is referred to as “including” another element, the element may further include other elements rather than excluding other elements unless otherwise mentioned. Terms such as “unit”, “module,” and the like, when used herein, represent units for processing at least one function or operation, which may be implemented by hardware, software, or a combination of hardware and software.

The expression “at least one of a, b, and c” described in the entire specification should be understood to include ‘a alone’, ‘b alone’, ‘c alone’, ‘a and b’, ‘a and c’, ‘b and c’, or ‘a, b, and c’.

The term “terminal”, when used herein, may be embodied as a computer or a portable terminal capable of being connected to a server or other terminal via a network. Here, the computer may include, for example, a notebook computer, a desktop computer, a laptop computer, etc., in which a web browser is installed, and the portable terminal is a wireless communication device that ensures portability and mobility and may include, for example, various types of handheld wireless communication devices, such as a terminal, a smartphone, a tablet PC, etc. based on communication such as International Mobile Telecommunication (IMT), Code Division Multiple Access (CDMA), W-Code Division Multiple Access (W-CDMA), Long-Term Evolution (LTE) or the like.

Example embodiments of the present disclosure will be described in detail with reference to the accompanying drawings below so that they may be easily implemented by those of ordinary skill in the art. However, the present disclosure may be embodied in many different forms and is not limited to the example embodiments of the present disclosure set forth herein.

Hereinafter, example embodiments of the present disclosure will be described in detail with reference to the accompanying drawings.

When example embodiments are described herein, a description of techniques that are well known in the technical field to which the present disclosure pertains and are not directly related to the present disclosure will be omitted. This is to more clearly convey the gist of the present disclosure by omitting unnecessary description.

For the same reason, some components are exaggerated, omitted, or schematically illustrated in the accompanying drawings. The size of each component does not entirely reflect the actual size thereof. The same reference numerals are allocated to the same or corresponding elements in each drawing.

Advantages and features of the present disclosure and methods of achieving them will be apparent from embodiments described below in detail in conjunction with the accompanying drawings. However, the present disclosure is not limited to the example embodiments below and may be embodied in many different forms. Rather, these embodiments are provided so that this disclosure will be thorough and complete and will fully convey the concept of the present disclosure to those of ordinary skill in the art. The present disclosure should be defined by the scope of the claims. The same reference numerals refer to the same components throughout the specification.

In this case, it will be understood that each block of process flowcharts and combinations of the flowcharts may be performed by computer program instructions. The computer program instructions may be installed in a processor of a general-purpose computer, special-purpose computer, or other programmable data processing equipment, so that means to perform functions described in blocks of each flowchart may be produced by instructions executed by the processor of the computer or the other programmable data processing equipment. The computer program instructions may be stored in a computer usable or readable memory directed to a computer or other programmable data processing equipment to implement functions in a particular way. Thus, an article of manufacture, including an instruction means for performing the function described in a block (or blocks) of each flowchart, may be produced by the instructions stored in the computer usable or readable memory. Because the computer program instructions may be stored in a computer or other programmable data processing equipment, the functions of the blocks of each flowchart may be provided by the instructions performing a series of operations in the computer or the other programmable data processing equipment to produce a process executable by the computer to generate a computer programmable instructions to operate the computer or the other data processing equipment.

In addition, each block may represent a module, segment, or part of code that includes one or more executable instructions for executing specified logical function(s). It should be noted that in some alternative embodiments of the present disclosure, the functions described in the blocks may be performed in an order different from that described herein. For example, two blocks illustrated consecutively may be performed substantially simultaneously or performed in a reverse order according to functions corresponding thereto in some cases.

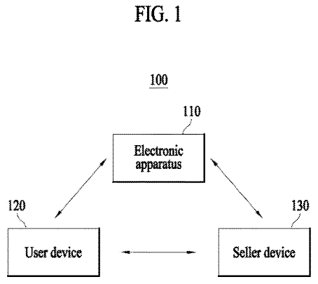

FIG. 1 is a schematic configuration diagram illustrating an item sales information processing system according to an example embodiment.

According to various example embodiments, an item sales information processing system 100 includes an electronic apparatus 110, a user device 120, and a seller device 130. According to an example embodiment, the item sales information processing system 100 may further include a first server corresponding to a first payment method, a logistics server that manages warehousing, releasing, and delivery, and the like. According to an example embodiment, the item sales information processing system 100 may further include a network that supports the exchange of information between at least some of the electronic apparatus 110, the user device 120, the seller device 130, and other external devices.

Each of the electronic apparatus 110, the user device 120, and the seller device 130 may include a transceiver, a memory, and a processor. Each of the electronic apparatus 110, the user device 120, and the seller device 130 may refer to a unit that processes at least one function or operation and may be implemented by software, hardware, or a combination of hardware and software. Generally, in example embodiments, the electronic apparatus 110, the user device 120, and the seller device 130 are referred to as separate servers but may be structures logically distinguishable from one another or may be implemented by separated functions in a server.

The user device 120 and the seller device 130 are named for convenience of description, but the user device 120 may correspond to or include a user who is an ordinary person and the seller device 130 may also correspond to or include a seller who is an ordinary person. However, for convenience of description, an example embodiment of the present disclosure is performed, in which the user device 120 and the seller device 130 in the item sales information processing system 100 exchange data, will be described below.

According to an example embodiment, the electronic apparatus 110, the user device 120, and the seller device 130 may include a plurality of computer systems or computer software implemented as network servers. For example, the electronic apparatus 110, the user device 120, and the seller device 130 may refer to computer systems and computer software configured to receive a request to perform a task, perform the task, and provide a result of performing the task, when connected to a sub-device for communication with another network server through a computer network such as an intranet or the Internet. Alternatively, at least some of the electronic apparatus 110, the user device 120, and the seller device 130 may be understood as a broad concept including a series of application programs executed in a network server and various databases installed in the network server. For example, at least some of the electronic apparatus 110, the user device 120, and the seller device 130 may be implemented using various network server programs provided according to an operating system such as DOS, Windows, Linux, Unix, Mac OS, etc.

The electronic apparatus 110 may configure and provide various pieces of information in the form of a web page. Specifically, the electronic apparatus 110 may be an apparatus that provides item sales information to a user. The electronic apparatus 110 obtains a purchase request that includes information related to an item selected by a user and information related to a payment option in order to provide information. The item may be an item that is displayed on the electronic apparatus 110 and is purchasable online by a user (a customer who is a purchaser) through the electronic apparatus 110. A purchase request for an item may be received from the user device 120.

When item information corresponding to the item and information related to a payment option satisfy a first condition, the electronic apparatus 110 provides the user with a purchase response, including approval information corresponding to the purchase request, in response to the purchase request, prior to the payment of the item through the payment option. The payment option may correspond to a first payment option for use of a “pay later” service, and the “pay later” service may correspond to a service that allows a user to purchase an item prior to the payment of the item and pay the cost afterwards. That is, in an example embodiment, this service will be described as the “pay later” service and may be understood as a service that allows a user to pay for an item later. The purchase response may be provided to the user device 120.

For convenience of description, an example embodiment in which a payment option corresponds to the first payment option for use of the “pay later” service will be described below. However, it should be understood that payment through the payment option is not limited to the example embodiment using the “pay later” service and may further include an example embodiment in which an examination of a financial institution (a bank or the like), a temporary payment error, or the like occurs.

The electronic apparatus 110 generates release request information for an item. The electronic apparatus 110 may transmit a release request to the seller device 130, a logistics server 310, or another external device, based on the release request information for the item. The release request may correspond to a request to release at least part of the items from a distribution center and deliver the item, and a device or server receiving the release request may perform a process of releasing and delivering the item. For example, the logistics server 310 receiving the release request may instruct a distribution center corresponding to the user's destination to release and deliver the item.

The electronic apparatus 110 generates settlement information corresponding to the cost of the item. Based on the settlement information, the cost of the item is settled with the seller of the item. Specifically, the cost may be settled by sending the cost corresponding to the settlement information to the seller device 130 of the item on the basis of the settlement information, sending the cost corresponding to the settlement information according to information of an account registered in advance corresponding to the seller device 130, or transmitting the settlement information to the seller device 130.

When a settlement date corresponding to the first payment option is approaching, the electronic apparatus 110 may request payment of at least part of the costs corresponding to one or more purchase requests related to the first payment option. Specifically, the electronic apparatus 110 may transmit a payment request to a first server corresponding to a first payment method designated to correspond to the first payment option. In this regard, the first payment method may correspond to a specific payment method, e.g., payment with points, a wire transfer/direct deposit, payment by a credit/debit card, or payment by a mobile phone, and the first server may be a server configured to handle a transaction related to the specific payment method.

The electronic apparatus 110 may change the settlement date corresponding to the first payment option. For example, when a request to change the settlement date is received from a user or a seller, the settlement date related to at least some of items purchased by the user or sold by the seller may be changed. When a request to change the settlement date in relation to the “pay later” service is received from an administrator of the electronic apparatus 110 or the like, the settlement date may be changed. In addition, the settlement date may be changed on the basis of whether there are various events that may change the settlement date in response to provision of the “pay later” service.

According to an example embodiment, whether to change the settlement date corresponding to the first payment option may be determined on the basis of at least one of seller information corresponding to the seller, user information corresponding to the user, and item information. For example, when it is determined that the seller or the user is not reliable or that it is not desirable to provide the “pay later” service for a certain item, the electronic apparatus 110 may provide a response to reject a request to extend the settlement date to at least one of the user and the seller or may advance the settlement of account due and provide this fact to at least one of the user and the seller.

According to an example embodiment, the electronic apparatus 110 may change a settlement method by changing the settlement date only for part of the cost scheduled to be paid in relation to the first payment option. For example, the electronic apparatus 110 may request a payment of 50% of the cost scheduled to be paid on a first settlement date prior to changing the settlement method, and extend the settlement date for the remaining 50% scheduled to be paid on a second settlement date after changing the settlement method.

However, example embodiments are not limited thereto, and the settlement date or the settlement method may be changed in various ways.

The payment request may correspond to a request for payment of the costs corresponding to at least a part of at least one purchase request (hereinafter referred to as ‘payment amount’). Specifically, the payment request may correspond to a request to send, by the first server, the payment amount on the basis of account information corresponding to the user and transmit settlement information including transfer details of the payment amount to the electronic apparatus 110. The payment request may include account information corresponding to the first payment option, and when the account information corresponding to the first payment option has been registered in advance, the registered account information may be transmitted. In an example embodiment, the user may execute a plurality of payment option to use the “pay later” service, and request to pay the settlement amount sequentially through the plurality of payment option according to the user's settings or an operation of the electronic apparatus 110.

The user device 120 may include a computer device, a mobile communication terminal, a server, or the like. The user device 120 refers to a terminal that is operated and managed by the user and may be a terminal that the user uses to perform an operation of purchasing an item.

The seller device 130 may include a computer device, a mobile communication terminal, a server, or the like. The seller device 130 refers to a terminal that is operated and managed by the seller and may be a terminal that the seller uses to perform an operation of selling an item.

An item sold by the seller through the electronic apparatus 110 may be stored in a distribution center corresponding to the electronic apparatus 110, another external place, or the like according to a management method or may be stored directly by the seller in an example embodiment. When the seller stores items in an external place rather than the distribution center or stores the items by the seller, the release request corresponding to the release request information may be transmitted directly to the seller device 130. On the other hand, when the item sold by the seller through the electronic apparatus 110 is stored in the distribution center, the release request for the item may be transmitted to a logistics server which is a server managing the distribution center for storing and delivering items sold online through the electronic apparatus 110.

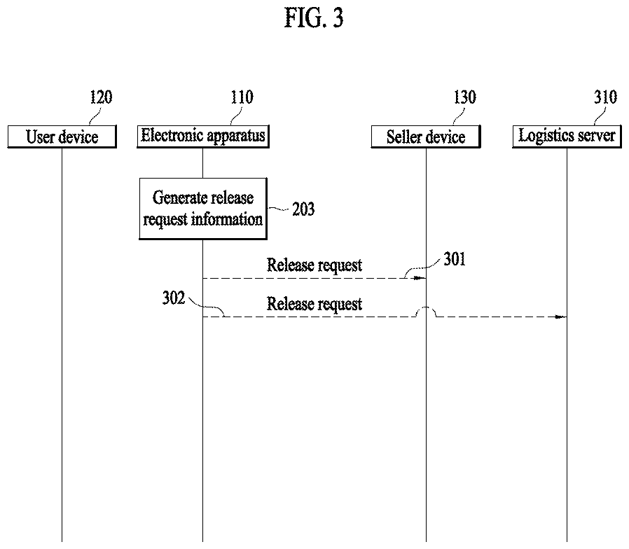

The transmission of the release request will be described in detail with reference to FIG. 3 below.

The first server may be a server corresponding to the first payment method. Specifically, the first payment method may correspond to a transfer of a payment amount on the basis of account information managed by the first server. According to an example embodiment, the first server may correspond to a server managed by a specific financial institution. For example, the first server may correspond to a server managed by an XX bank. The first server receiving a payment request from the electronic apparatus 110 may determine whether account information included in the payment request is valid and determine whether account balances corresponding to the account information is greater than or equal to the payment amount scheduled to be paid. According to a determination result, the first server may transfer the payment amount to the electronic apparatus 110 or transmit payment failure information to the electronic apparatus 110.

A series of operations related to item sales information processing methods according to various example embodiments may be implemented by a single physical device or a plurality of physical devices which are organically coupled to one another. For example, some of the components included in the item sales information processing system 100 may be implemented by a physical device and the other components may be implemented by another physical device. For example, a physical device may be implemented as a part of the electronic apparatus 110, and another physical device may be implemented as a part of the user device 120, the seller device 130, or another external device (the first server, the logistics server or the like). In some cases, the components included in the item sales information processing system 100 may be distributed and disposed in different physical devices, and organically coupled to one another to perform functions and operations of the item sales information processing system 100. For example, the electronic apparatus 110 described herein may include at least one sub-device, and some of the operations described as being performed by the electronic apparatus 110 may be performed by a first sub-device and the other operations may be performed by a second sub-device.

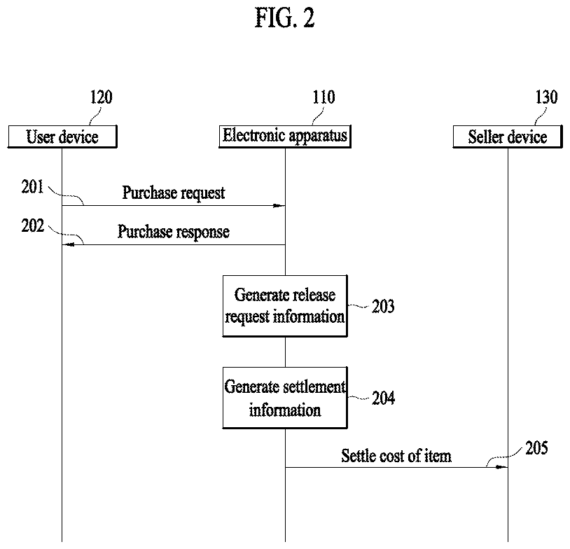

FIG. 2 is a flowchart of an information processing method in an item sales information processing system according to an example embodiment.

Referring to FIG. 2, in operation 201, an electronic apparatus 110 according to an example embodiment obtains a purchase request, including item information and information related to a first payment option, from a user device 120. As described above, the first payment option may correspond to the “pay later” service.

When item information corresponding to an item and information related to a payment option satisfy a first condition, in operation 202, the electronic apparatus 110 provides a user with a purchase response, including approval information corresponding to the purchase request, in response to the purchase request, prior to the payment of the item through the payment option. Specifically, the item information included in the purchase request includes price information of the item, and the information related to the first payment option may include at least one of information as to whether the first payment option is available and balance information related to a limit amount of the first payment option. The limit amount of the first payment option may correspond to a limit of an amount that is set to pay for an item using the first payment option, and the balance information may correspond to an amount of the limit amount, which has yet to be used to pay for an item. For example, it may be understood that when a limit amount to be paid during the month of July is 300,000 won and balance information indicates 170,000 won, a total of 300,000 may be paid to purchase items for July, 130,000 won was paid to purchase items, and items corresponding to 170,000 may be purchased for the remaining days of July.

According to an example embodiment, the information related to the first payment option may include residual quantity information related to quantity information of an item that may be purchased using the first payment option. For example, it may be understood that when a limit quantity of a certain item that may be paid for during a month of July is ten and residual quantity information indicates seven, a quantity of ten of the item may be purchased using the first payment option for the month of July, a quantity of three of the item is currently purchased, and a quantity of seven of the item may be further purchased for the remaining days of July.

For convenience of description, an example embodiment in which information related to the first payment option includes balance information related to the limit amount of the first payment option will be described below.

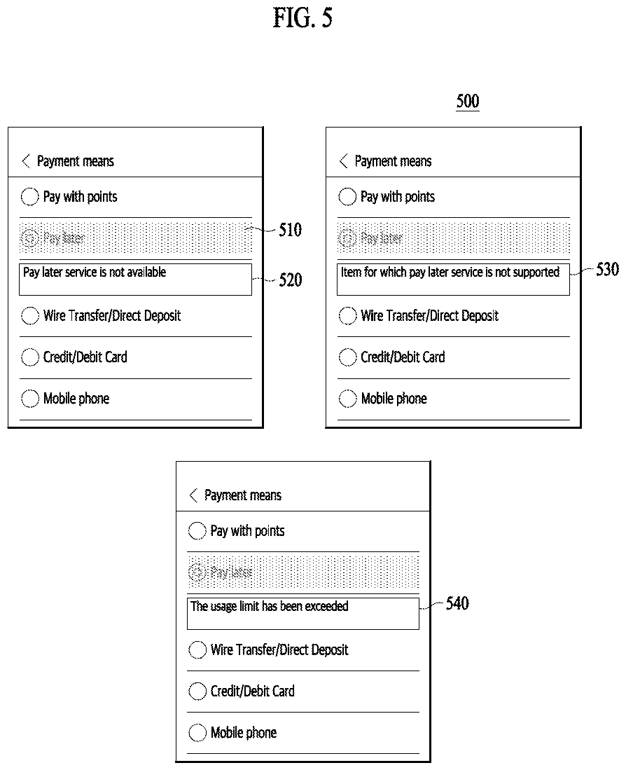

The electronic apparatus 110 may determine whether the first condition is satisfied on the basis of at least one of the price information of the item, whether the first payment option is available, and the balance information of the first payment option, in relation to the obtaining of the purchase request. Specifically, the electronic apparatus 110 may determine whether the first payment option is available and whether balance of the limit amount is greater than or equal to a payment amount for purchasing the item, and determine that the first condition is satisfied only when the first payment option is available and the balance of the limit is greater than or equal to the payment amount for purchasing the item. In this regard, when the balance information related to the limit amount is less than an amount corresponding to the purchase request of the item or when the first payment option is not available, the electronic apparatus 110 according to an example embodiment may provide information for rejection of the purchase request, as will be described with reference to FIG. 5 below.

According to an example embodiment, when balance of the limit amount of the first payment option is less than a payment amount for purchasing the item after providing the purchase response, the electronic apparatus 110 may cancel an approval corresponding to the purchase request and provide information indicating the cancellation of the approval to the user. According to an example embodiment, when balance of the limit amount of the first payment option becomes less than the payment amount for purchasing the item after the electronic apparatus 110 transmits the release request, the electronic apparatus 110 may additionally transmit a request to cancel the release request.

Whether the first payment option is available and the limit amount of the first payment option may be determined on the basis of various factors. According to an example embodiment, whether the first payment option is available and the limit amount of the first payment option may be determined on the basis of at least one of the seller information corresponding to the seller and the user information corresponding to the user corresponding to the user device 120.

The user information may include at least one of a purchase history corresponding to one or more users, rating information corresponding to the one or more users, a subscription period corresponding to the one or more users, and a credit score corresponding to the one or more users. According to an example embodiment, the user information may include reliability set in relation to the user. The reliability set in relation to the user may be an indicator as to whether the user is reliable enough to pay a payment amount without late payment when the “pay later” service is provided to the user.

The reliability set in relation to the user according to an example embodiment may be set based on at least one of a purchase history corresponding to the user, rating information corresponding to the user, a subscription period corresponding to the user, a credit score corresponding to the user, and user information obtained from an affiliate. In this regard, the credit score corresponding to the user may be determined based on at least one of information obtained from a credit rating agency and information obtained by the electronic apparatus 110. In addition, the affiliate may include at least one of a communication carrier, a payment gateway (PG), and a public institution. The user information obtained from the affiliate may include at least one of payment system information, roaming information, and various pieces of billing information obtained from the communication carrier. The user information obtained from the PG may include at least one of mobile phone payment information and various pieces of billing information. The user information obtained from the public institution may include at least one of tax information and utility bill information. Furthermore, the reliability may be set based on at least one of a service subscription date of the user, information about a payment option registered by the user, an amount charged by the user for the immediate payment service, and an amount accumulated for the user, in relation to an immediate payment service provided by the electronic apparatus 110.

The user's purchase history may include at least one of a list of one or more items purchased by the user, a payment option used by the user to pay for the one or more items, product reviews written by the user, a late payment history of the user related to the payment of the one or more items, information related to a destination corresponding to the one or more items, and information related to the user device 120 used by the user to pay for the one or more items. In this regard, the information related to the destination may include at least one of the address of the destination, the number of destinations, a history of change of destination, and whether destinations corresponding to a recent purchase history are the same. The information related to the user device 120 may include at least one of Internet protocol (IP) information corresponding to the user device 120, an operating system used by the user device 120, and the user device 120 model.

The rating information may include information on a rating related to the electronic apparatus 110, and information regarding a rating corresponding to one or more payment methods.

The above description related to the user information may apply to not only to the user corresponding to the user device 120 but also other users, as will be described in detail below.

The seller information may include at least one of a sales history corresponding to the seller, rating information corresponding to the seller, a subscription period corresponding to the seller, a credit score corresponding to the seller, and information obtained from an affiliate. According to an example embodiment, the seller information may include reliability set in relation to the seller. The reliability may be an indicator as to whether the seller is reliable enough to not conduct an abusing behavior such as abusing the “pay later” service when the “pay later” service is provided. In this regard, examples of the abusing behavior may include a case in which the seller sets price information of an item to a very high price, compared to a generally accepted value and price of the item, and purchases the item using the first payment option while scheming with a certain user or pretending to be a user. For example, the seller may set price information of a box of apples, which is generally worth 10,000 won, as 1,000,000 won and a user who is scheming with the seller may purchase the box of apples using the first payment option. When the user delays payment of the amount corresponding to a purchase request related to the first payment option or vanishes without paying the amount, the seller may earn 1,000,000 won at a cost of 10,000 won and thus make an unfair profit of 990,000 won.

The reliability according to an example embodiment may be set based on at least one of a sales history corresponding to the seller, rating information corresponding to the seller, a subscription period corresponding to the seller, a credit score corresponding to the seller, and user information obtained from an affiliate. In this regard, the credit score corresponding to the seller may be determined based on at least one of information obtained from a credit rating agency and information obtained by the electronic apparatus 110. In addition, as described above for the user information, the affiliate may include at least one of a communication carrier, a payment gateway (PG), and a public institution. The seller information obtained from the affiliate may include at least one of payment system information, roaming information, and various pieces of billing information obtained from the communication carrier. The seller information obtained from the PG may include at least one of mobile phone payment information and various pieces of billing information. The seller information obtained from the public institution may include at least one of tax information and utility bill information. In addition, the reliability may be further set based on at least one of a service subscription date of the seller, payment option information or account information registered by the seller, an amount deposited by the seller, and an amount accumulated for the seller.

The seller's sales history may include at least one of a list of one or more items sold by the seller, a list of one or more items that are for sale by the seller, a payment option used to pay for one or more items sold by the seller, product reviews written by the seller, and information related to the seller device 130 used by the seller to sell one or more items. In this regard, the information related to the seller device 130 may include at least one of IP information corresponding to the seller device 130, an operating system used by the seller device 130, and the seller device 130 model.

The reliability of the seller may be evaluated on the basis of a result of judging other sellers' sales histories, rating information, subscription periods, credit scores, seller information obtained from an affiliate, etc. and whether sellers have committed abusing actions. For example, as a result of analyzing statistics related to other sellers, the more items sold, the higher the rating information, the longer the subscription period, and the higher the credit score, the lower the possibility of abusing behavior by the seller, and when judging reliability, the more items sold, the higher the rating information, the longer the subscription period, and the higher the credit score, the higher the reliability.

According to an example embodiment, different weights may be assigned to individual factors considered to determine reliability. For example, when a correlation between a credit score and the probability of abusing behavior is far greater than a correlation between another factor and the probability of abusing behavior (that is, as the credit score increases, the probability of abusing behavior significantly decreases), a high weight may be assigned to the credit score when individual factors are considered.

According to an example embodiment, the seller information may include information on a limit amount permitted by the seller to allow the purchase of an item using the first payment option. The limit amount information may be set for a specific item or some or all of the items that are for sale by the seller. For example, the seller may permit the purchase of specific items worth 1,000,000 won, which are for sale by the seller, using the first payment method for one month.

According to an example embodiment, the seller information may include information on a limit quantity permitted by the seller to allow the purchase of an item using the first payment option.

According to an example embodiment, whether the first payment option is available and a limit amount of the first payment option may be determined on the basis of the item information. The item information may include at least one of category information of the item, information about a comparison between the price information of the item and another piece of price information, quantity information of the item that is for sale, and at least one piece of user information corresponding to one or more users who have purchased the item.

In relation to the category information of the item, when an item corresponding to a purchase request belongs to a certain category, the first payment option may become unavailable or the limit amount of the first payment option may be changed. For example, when an item corresponding to a purchase request is an item with a high default rate (for example, an expensive luxury item, an item that is popular among teenagers, or the like) when the “pay later” service is used or is an item with high liquidity (for example, gold bar), the limit amount may be significantly reduced to prevent, in advance, non-payment of the item and the urge for making money by reselling the item. In an example embodiment, a subject associated with an operator of a service related to the electronic apparatus 110 may directly manage purchases and first apply the “pay later” service to a product to be delivered. By applying the “pay later” service only to such an item, a settlement procedure associated with the item may be easily performed even when a user does not pay for the item.

According to an example embodiment, the first payment option may become unavailable or the limit amount of the first payment option may be changed depending on whether the item is a target for delivery. For example, the use of the first payment option may be limited only when the item is not a target for delivery, e.g., a digital goods. In this case, the electronic apparatus 110 may provide a purchase response for the item when the item is a target for delivery, and provide information for rejection of the purchase request for the item when the item is not a target for delivery.

In this regard, the category information of the item may include information as to whether the item is a target for delivery or the electronic apparatus 110 may additionally determine whether the item is a target for delivery.

In connection with the information about the comparison between the price information of the item and another piece of price information, the price information of the item is set to a much higher price than the price of an item similar to or the same as the item which is sold by another seller, the first payment option may become unavailable or the limit amount of the first payment option may be changed in order to prevent abusing behavior. For example, when a box of applies that is generally worth 10,000 won is sold for 1,000,000 won, the first payment option may become unavailable or the limit amount of the first payment option may be changed. When the first payment option becomes unavailable, the electronic apparatus 110 may provide the information for rejection of the purchase request to at least one of the user and the seller.

Based on the at least one piece of user information corresponding to one or more users purchasing the item, whether a sales history associated with the one or more users who have purchased the item has been manipulated or corresponds to an abnormal transaction may be determined, and a degree of reliability of the number of sales may be determined. The at least piece of user information corresponding to the one or more users may include at least one of a purchase history corresponding to the one or more users, rating information corresponding to the one or more users, subscription periods of the one or more users, and credit scores corresponding to the one or more users, and the above description of the user information of the user corresponding to the user device 120 may apply thereto.

According to an example embodiment, when the reliability of the seller is higher than a first predetermined value, the electronic apparatus 110 may further provide benefits related to sales of the item. For example, the electronic apparatus 110 may provide a fee reduction benefit, a point accumulation benefit, etc. in relation to providing services for sales of the item. Therefore, the electronic apparatus 110 may induce the seller to sell items online through the electronic apparatus 110. Alternatively, the electronic apparatus 110 may provide benefits only when the seller sells an item in response to a purchase request through the first payment option or provide greater benefits when the seller sells an item in response to a purchase request through the first payment option, so that the seller may sell an item in response to a request to buy the item from a user through the “pay later” service.

According to an example embodiment, the limit amount of the first payment option may be determined in stages. For example, the electronic apparatus 110 may determine whether a user is able to subscribe to the first payment option and first determine a limit amount of the first payment option, and secondly determine a limit amount of the first payment option, in response to a request to subscribe to the “pay later” service or a request to purchase an item using the first payment option by the user. In this case, the electronic apparatus 110 may secondly determine a limit amount of the first payment option on the basis of at least part of the seller information.

For example, the electronic apparatus 110 may determine whether the user is able to subscribe to the first payment option and first determine a limit amount of the first payment option on the basis of information such as a purchase history corresponding to the user, rating information corresponding to the user, a subscription period corresponding to the user, etc. Thereafter, when a purchase request is received from the user, the electronic apparatus 110 may secondly determine a limit amount of the first payment option on the basis of information such as a sales history corresponding to a seller who sells the item corresponding to the user's purchase request, rating information corresponding to the seller, a subscription period corresponding to the seller, etc. However, this is only an example, and the first determination of the limit amount of the first payment option is not necessarily made on the basis of the user information and the second determination thereof is not necessarily made on the basis of the seller information.

According to an example embodiment, whether the first payment option is available and the limit amount of the first payment option may be periodically determined when a settlement date corresponding to the first payment option is approaching. For example, as described above, the limit amount may correspond to a total amount of money that may be paid for a month, e.g., “the month of July” and may be newly determined when the month changes (e.g., when August arrives). Alternatively, the limit amount may be changed on the basis of whether the payment of the amount of money used by the user was settled on the settlement date.

According to an example embodiment, whether the first payment option is available and the limit amount of the first payment option may be determined whenever a purchase request is received. In this case, whenever a purchase request is received from the user, the reliability of the user may be determined. In this case, even when an event, which may badly affect the reliability of the user, e.g., the user's late payment or a sudden decline in the user's credit score, occurs, the event may further be considered to determine whether the first payment option is available and determine the limit amount of the first payment option on the basis of all of the event.

According to an example embodiment, whether the first payment option is available and the limit amount of the first payment option may be determined each time the seller uploads item sales information to a site managed by the electronic apparatus 110 to sell items. In this case, even when an event, which may badly affect the reliability of the seller, e.g., a sudden decline in the seller's credit score, occurs, the reliability of the seller is determined each time the seller uploads new item sales information and thus whether the first payment option is available and the limit amount of the first payment option may be determined on the basis of all of the event.

When the information related to the payment option satisfies the first condition, the electronic apparatus 110 providing the purchase response generates release request information for the item in operation 203. The generated release request information may be transmitted to the seller device 130, a logistics server, or another external device, as will be described with reference to FIG. 3 below.

The electronic apparatus 110 may generate settlement information corresponding to the cost of the item in operation 204, so that the cost may be settled with a seller of the item on the basis of the settlement information in operation 205. As the cost of the item is paid, the seller may be provided with the amount paid for the sold item.

According to an example embodiment, the electronic apparatus 110 may settle the cost of the item with the seller when the cost of the item is paid by the user corresponding to the purchase request. In this case, because the cost of the item is not settled with the seller before the user pays the cost of the item, abusing attempts may be blocked and damage caused to the electronic apparatus 110 due to the user's late payment may be prevented but the seller in good faith may suffer damage when the user's late payment occurs.

According to an example embodiment, the electronic apparatus 110 may determine a settlement date so that the cost of the item may be settled with the seller when a settlement of date corresponding to a payment option is approaching. In this case, because the amount paid for the item is not provided to the seller until the predetermined settlement date, abusing attempts may be partially blocked and damage caused to the seller in good faith may be minimized. However, even in this case, when the user pays the cost of the item before the predetermined settlement date, the cost of the item may be settled with the seller.

According to an example embodiment, the electronic apparatus 110 may settle the cost of the item with the seller when a predetermined time has elapsed after the provision of the purchase response. Considering that the “pay later” service is a service provided by the electronic apparatus 110, it may be most reasonable to settle the cost of the item with the seller when the predetermined time elapses after the providing of the purchase response, because it is reasonable that a service provider corresponding to the electronic apparatus 110 should bear the possibility of damages due to the “pay later” service. However, in this case, additional measures may be required to prevent abusing of the seller and the user's late payment.

According to an example embodiment, the electronic apparatus 110 may separately manage the amount paid by the user and settled with the seller and the amount settled with the seller before it is paid by the user. In this case, the settlement information may include first settlement information corresponding to the amount paid by the user and settled with the seller in response to the purchase request, and second settlement information corresponding to the amount settled with the seller before it is paid by the user.

When a settlement date corresponding to the first payment option is approaching as indicated by the settlement information generated in operation 204, the electronic apparatus 110 may request payment of at least part of the costs corresponding to one or more purchase requests related to the first payment option. The electronic apparatus 110 may request payment by transmitting a payment request to a first server corresponding to a first payment method designated to correspond to the first payment option. When the payment amount is successfully transferred from the first server, the first server may transmit payment information including transfer details of the payment amount to the electronic apparatus 110. The electronic apparatus 110 may confirm the successful transfer of the payment amount by receiving the payment information.

FIG. 3 is a flowchart of an operation of requesting to deliver an item by an electronic apparatus in an item sales information processing system according to an example embodiment.

Referring to FIG. 3, an electronic apparatus 110 according to an example embodiment generates release request information for an item in operation 301. The electronic apparatus 110 may transmit a release request to a seller device 130, a logistics server 310, or another external device, based on the release request information for the item. In this regard, the logistics server 310 may be a server that manages a distribution center for storing and delivery of items that are for sale through the electronic apparatus 110. According to an example embodiment, the logistics server 310 may be a server that manages a plurality of distribution centers in an integrated manner or a system in which servers of the distribution centers are connected via a network.

The release request transmitted from the electronic apparatus 110 may correspond to a request to release at least part of the items from the distribution center and deliver the item, and a device or server receiving the release request may perform a procedure of releasing and delivering the item. For example, the logistics server 310 receiving the release request may instruct a distribution center corresponding to the user's destination to release and deliver the item.

An item sold by the seller through the electronic apparatus 110 may be stored in a distribution center corresponding to the electronic apparatus 110, another external place, or the like according to a management method or may be stored directly by the seller in an example embodiment. When the seller stores the item in an external place other than the distribution center or stores the item by the seller, the release request corresponding to the release request information may be transmitted directly to the seller device 130 in operation 301. On the other hand, when the seller stores the item sold through the electronic apparatus 110 in the distribution center, in operation 302, the release request for the item may be transmitted to the logistics server 310 which is a server managing the distribution center online.

The seller device 130, the logistics server 310, or another external device receiving the release request for at least part of the items may release the item and deliver the released item to an input address. When a request to cancel the release request is received for the item when the delivery of the item is not started, the delivery of the item may be canceled.

According to an example embodiment, when a balance of the limit amount of the first payment option is less than a payment amount for purchasing the item after providing the purchase response, the electronic apparatus 110 may cancel an approval corresponding to the purchase request and provide information indicating the cancellation of the approval to the user. According to an example embodiment, when a balance of a limit amount of the first payment option becomes less than the payment amount for purchasing the item after the electronic apparatus 110 transmits the release request, the electronic apparatus 110 may additionally transmit a request to cancel the release request.

A purchase response is not necessarily made for the electronic apparatus 110 to generate the release request information or transmit the release request. For example, when item information and information related to a payment option satisfy a first condition, the electronic apparatus 110 may provide the release request to the seller device 130, the logistics server 310 or another external device while providing the purchase response to the user device 120. Alternatively, according to an example embodiment, the electronic apparatus 110 may first provide the release request to the seller device 130, the logistics server 310, or another external device and thereafter provide the purchase response to the user device 120.

The seller device 130, the logistics server 310, or another external device receiving the release request may prepare for the release and delivery of the item.

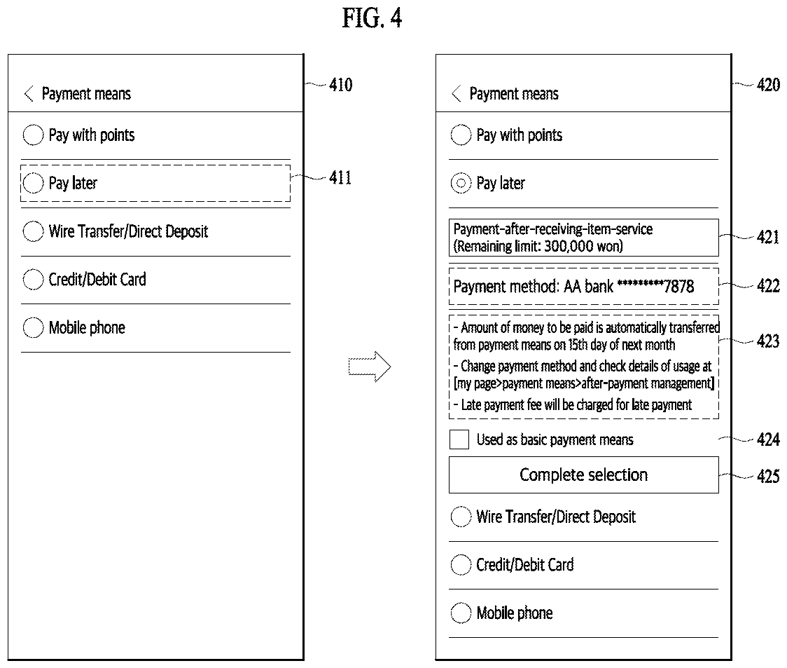

FIG. 4 is a diagram for describing an example of a user interface (UI) provided by an electronic apparatus to provide a “pay later” service in an item sales information processing system according to an example embodiment.

Referring to FIG. 4, the electronic apparatus 110 according to an example embodiment may provide a user with a UI for providing the “pay later” service, which is a payment service using a first payment option. The “pay later” service may be displayed such that a user may select the “pay later” service from among a plurality of payment option as indicated by a dashed box 411. As indicated by reference numeral 410, the plurality of payment option may include at least one of point payment, wire transfer/direct deposit, a credit/debit card, and a mobile phone payment.

When a UI selection input corresponding to the “pay later” service is obtained from a user, additional information related to the “pay later” service may be further displayed as indicated by reference numeral 420. The additional information according to an example embodiment may include at least some of a brief description of the “pay later” service and an limit amount 421 of a first payment option, information 422 about a first payment method designated to correspond to the first payment option, and information 423 related to a settlement date, a change of the first payment method, details of usage of the “pay later” service, and late payment fees. When a UI selection input corresponding to the “pay later” service is obtained from the user, an additional UI related to the “pay later” service may be further displayed, and the additional UI may include at least one of a UI field 424 for selecting whether the first payment option is to be used as a basic payment option (that is, whether an item is to be paid for through the first payment option at a later time when there is no additional input for selecting a payment option) and a UI field 425 for obtaining a selection input after the additional information related to the “pay later” service is provided to the user.

As described above, whether the first payment option is available and the limit amount of the first payment option may be determined on the basis of at least some of user information corresponding to a purchase request, seller information corresponding to a seller of an item, item information, and information corresponding to reference numeral 421 may indicate a determined limit amount.

FIG. 5 is a diagram for describing an example in which use of a “pay later” service is limited in relation to the purchase of an item in an item sales information processing system according to an example embodiment.

Referring to FIG. 5, when the “pay later” service according to an example embodiment is not available, a UI field for providing the “pay later” service may be deactivated as indicated by a shaded portion 510. When the UI field for providing the “pay later” service is deactivated, the electronic apparatus 110 may shade the UI and change a font size or color of characters so that the user may easily recognize the deactivation of the UI.

When the “pay later” service is not available, the electronic apparatus 110 may provide a rejection response to a purchase request from the user by providing the user with information notifying the unavailability of the “pay later” service. When the unavailability of the “pay later” service is not caused by the user (e.g., when the unavailability of the “pay later” service is caused by a seller of an item corresponding to the purchase request from the user or the item corresponding to the purchase request from the user), the electronic apparatus 110 may also provide the seller with the information notifying the unavailability of the “pay later” service.

According to an example embodiment, the information notifying the unavailability of the “pay later” service may include the same content regardless of why the “pay later” service-payment service is not available. For example, the information notifying the unavailability of the “pay later” service may include the phrase “Pay later service is not available” as indicated by a box 520.

According to an example embodiment, the information notifying the unavailability of the “pay later” service may include different content according to a cause of the unavailability of the “pay later” service. For example, when an item corresponding to the user's purchase request is not an item supported by the “pay later” service (e.g., an expensive luxury item, an item with high liquidity, a digital item that is not a target for delivery, or the like), the information notifying the unavailability of the “pay later” service may include the phrase “This item is not supported by the “pay later” service” as indicated by a box 530. As another example, when the limit amount of the first payment option is used up and thus there is no balance, the information notifying the unavailability of the “pay later” service may include the phrase “The usage limit has been exceeded” as indicated by a box 540.

In addition, according to an example embodiment, the information notifying the unavailability of the “pay later” service may include a phrase “Settlement method corresponding to the first payment method has been deleted.”, “There is overdue payment.”, “For more than 300,000 won, the “pay later” service is not available.“, “This seller is not supported by the “pay later” service.“, or the like.

A user who received a rejection response may confirm that the use of the “pay later” service corresponding to the first payment option is restricted. Furthermore, when the information notifying the unavailability of the “pay later” service may include different content according to a cause of the unavailability of the “pay later” service, the user may be able to understand what measures should be taken to use the “pay later” service.

According to an example embodiment, the information notifying the unavailability of the “pay later” service may be also provided to the seller.

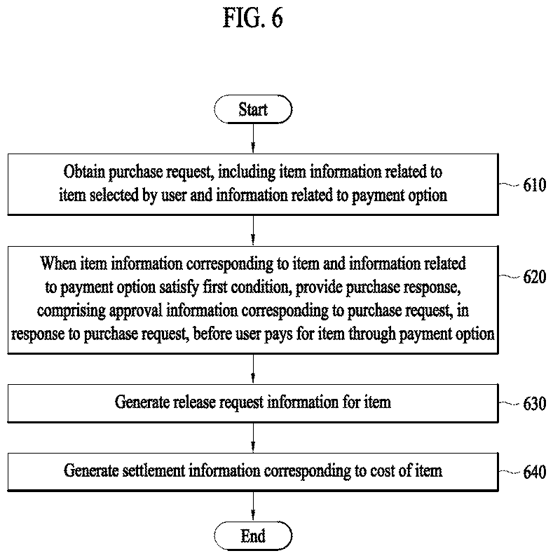

FIG. 6 is a flowchart of a method of processing item sales information by an electronic apparatus according to an example embodiment.

Referring to FIG. 6, in operation 610, the electronic apparatus 110 according to an example embodiment obtains a purchase request, including item information related to an item selected by a user and information related to a payment option.

When the item information corresponding to the item and the information related to the payment option satisfy a first condition, in operation 620, the electronic apparatus 110 provides a purchase response, including approval information corresponding to the purchase request, in response to the purchase request prior to the payment of the item through the payment option.

The electronic apparatus 110 generates release request information for the item in operation 630. The release request information may be transmitted to the seller device 130, a logistics server or another external device. Alternatively, a release request based on the release request information may be transmitted to the seller device 130, the logistics server or another external device.

The electronic apparatus 110 generates settlement information corresponding to the cost of the item in operation 640. The cost of the item is settled with the seller of the item on the basis of the settlement information.

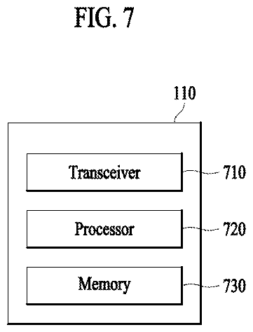

FIG. 7 is a diagram illustrating an example of a configuration of an electronic apparatus for processing item sales information according to an example embodiment.

Referring to FIG. 7, an electronic apparatus 110 includes a transceiver 710, a processor 720, and a memory 730. The electronic apparatus 110 may be connected to the user device 120, the seller device 130, a logistics server, a first server, other external devices, and the like to exchange data therewith through the transceiver 710.

The processor 720 may include at least one of the devices described above with reference to FIGS. 1 to 6 or perform at least one of the methods described above with reference to FIGS. 1 to 6. The memory 730 may store information (including at least some of item information, information related to a payment option, approval information, release request information, and settlement information) for performing at least one of the methods described above with reference to FIGS. 1 to 6. The memory 730 may be a volatile memory or a non-volatile memory.

The processor 720 may execute programs and control the electronic apparatus 110 for providing information. The code of a program executed by the processor 720 may be stored in the memory 730.

The electronic apparatus 110 according to an example embodiment may further include an interface for providing information to a user.

Although example embodiments of the present disclosure are set forth in the present specification and drawings and specific terms are used herein, they are merely provided in a general sense to easily explain the technical idea of the present disclosure and help understanding of the present disclosure and are not intended to limit the scope of the present disclosure. It will be obvious to those of ordinary skill in the art that other modified examples based on the technical spirit of the present disclosure can be implemented.

An electronic apparatus or a terminal according to the above-described example embodiments may include a processor, a memory storing and executing program data, a permanent storage such as a disk drive, a communication port for communication with external devices, a user interface device such as a touch panel, a key or a button, and the like. Methods implemented by a software module or an algorithm may be stored in a computer-readable medium in the form of computer-readable code or program instructions executable on the processor. Here, the computer-readable recording medium may include a magnetic storage medium (e.g., read-only memory (ROM), random-access memory (RAM), a floppy disk, a hard disk or the like) and an optical reading medium (e.g., a CD-ROM, a digital versatile disc (DVD) or the like). The computer-readable recording medium may be distributed over network coupled computer systems so that computer readable code may be stored and executed in a distributed fashion. The computer-readable recording medium is readable by a computer, stored in memory, and executed by a processor.

The example embodiments of the present disclosure may be represented by functional block configurations and various operations. The functional blocks may be implemented by various numbers of hardware and/or software configurations for performing certain functions. For example, in an example embodiment, integrated circuit configurations, such as a memory, a processor, a logic circuit, and a look-up table, which perform various functions under control of one or more microprocessors or other control devices may be employed. As components are executable by software programming or software elements, example embodiments may be also implemented with a programming or scripting language such as C, C++, Java, Assembler, and Python, including various algorithms implemented in a combination of data structures, processes, routines, or other programming configurations. Functional aspects may be implemented using an algorithm executable by one or more processors. In the example embodiments, conventional techniques may be employed for electronic configuration, signal processing, and/or data processing. Terms “mechanism”, “element”, “means”, “configuration”, etc. may be widely used and are not limited to mechanical and physical configurations. The terms may be understood to mean a series of routines of software in conjunction with a processor or the like.

The above-described example embodiments are merely examples and thus other example embodiments may be implemented within the scope of the following claims.

1. A method of processing item sales information by an electronic apparatus, the method comprising:
receiving a plurality of pieces of item information each associated with a first item;
storing the plurality of pieces of item information;
obtaining, from a first user device, a purchase request, wherein the purchase request includes item information related to an item selected by a user and information related to a payment option;
determining, based on the plurality of pieces of item information, whether a default rate for purchasing the item through the payment option is higher than a predetermined threshold;
sending, to the first user device and based on the determination, a purchase response in response to the purchase request, prior to payment of the item by the user through the payment option, the purchase response comprising approval information corresponding to the purchase request;
sending, based on the approval and to a logistics server configured to manage a plurality of distribution centers storing the first item, release request information for the item, wherein the release request information is configured to cause deliver the item from one of the plurality of distribution centers; and
sending, settlement information corresponding to a cost of the item,
wherein the cost is settled with a seller of the item on the basis of the settlement information.

2. The method of claim 1, wherein:
the item information comprises price information of the item;
the information related to the payment option comprises at least one of: whether the payment option is available or balance information related to a limit amount of the payment option; and
the sending the purchase response is further based on at least one of the price information of the item, whether the payment option is available, or the balance information of the payment option.

3. The method of claim 2, wherein whether the payment option is available and the limit amount of the payment option are determined based on at least one of: seller information corresponding to the seller or user information corresponding to the user.

4. The method of claim 3, wherein:
the seller information comprises reliability set in relation to the seller; and
the reliability set is based on at least one of: a sales history corresponding to the seller, rating information corresponding to the seller, a subscription period corresponding to the seller, a credit score corresponding to the seller, or information obtained from affiliates.

5. The method of claim 4, wherein the sales history comprises at least one of: a list of one or more items sold by the seller, a payment option used to pay for the one or more items, or product reviews written for the one or more items.

6. The method of claim 4, further comprising, when the reliability is greater than a predetermined first value, providing a benefit related to the sale of the item.

7. The method of claim 3, wherein the seller information comprises information about a limit amount, which is permitted by the seller, to purchase the item using the payment option.

8. The method of claim 2, wherein whether the payment option is available and the limit amount of the payment option are determined based on the item information.

9. The method of claim 8, wherein whether the payment option is available and the limit amount of the payment option are determined based on at least one of: category information of the item, information about a comparison between the price information of the item and another piece of price information, information about a number of sales of the item, or at least one piece of user information corresponding to one or more users who have purchased the item.

10. The method of claim 9, wherein the at least one piece of the user information comprises at least one of: a purchase history corresponding to the one or more users, rating information corresponding to the one or more users, a subscription period corresponding to the one or more users, or a credit score corresponding to the one or more users.

11. The method of claim 1, further comprising, as a settlement date corresponding to the payment option is approaching, requesting the user to pay at least part of costs corresponding to one or more purchase requests related to the payment option.

12. The method of claim 11, wherein the requesting the user to pay at least part of the costs comprises transmitting a payment request to a first server corresponding to a first payment method designated to correspond to the payment option.

13. The method of claim 1, wherein the sending of the settlement information comprises determining to settle the cost of the item with the seller when the user pays the cost of the item, in response to the purchase request.

14. The method of claim 1, wherein the sending of the settlement information comprises determining to settle the cost of the item with the seller when a settlement date corresponding to the payment option is approaching.

15. The method of claim 1, wherein the sending of the settlement information comprises determining to settle the cost of the item with the seller when a predetermined time elapses after the sending of the purchase response.

16. The method of claim 1, wherein the settlement information comprises first settlement information corresponding to an amount paid by the user and settled with the seller, and second settlement information corresponding to an amount settled with the seller before the amount is paid by the user in response to the purchase request.

17. The method of claim 1, wherein the sending of the purchase response comprises:
determining whether the item is a target for delivery;
when the item is a target for delivery, providing the purchase response for the item; and
when the item is not a target for delivery, providing information for rejection of the purchase request for the item.

18. A non-transitory computer-readable recording medium storing a program for executing the method of claim 1 in a computer.

19. An electronic apparatus for processing item sales information, the electronic apparatus comprising a transceiver, a memory configured to store instructions, and a processor, wherein the processor is connected to the transceiver and the memory, and wherein the instructions configured to, when executed, cause the processor to:
receive a plurality of pieces of item information each associated with a first item;
store the plurality of pieces of item information;
obtain, from a first user device, a purchase request, wherein the purchase request includes item information related to an item selected by a user and information related to a payment option;
determine, based on the plurality of pieces of item information, whether a default rate for purchasing the item through the payment option is higher than a predetermined threshold;
send, to the first user device and based on the determination, a purchase response in response to the purchase request, prior to payment of the item by the user through the payment option, the purchase response including approval information corresponding to the purchase request; and
send, based on the approval and to a second devicelogistics server configured to manage a plurality of distribution centers storing the first item, release request information for the item, wherein the release request information is configured to cause deliver the item from one of the plurality of distribution centers; and
send, settlement information corresponding to cost of the item,
wherein the cost of the item is settled with a seller of the item on the basis of the settlement information.

20. The method of claim 1, wherein the sending of the purchase response is based on a price of the item is higher than a piece of price information by a predetermined amount.

21. The method of claim 1, wherein the default rate is determined based on whether the item belongs to a category that is popular among a demographical group.
